(19) United States
(12) Patent Application Publication
(10) Pub. No.: US 2024/0268428 A1
(43) Pub. Date: Aug. 15, 2024

(54) FLAVOUR DELIVERY SYSTEM

(71) Applicant: Givaudan SA, VERNIER (CH)

(72) Inventors: Lisa Maria WIJNEN, Hilversum (NL); Rudolf RINGGENBERG, Baeretswil (CH); Frans WITTEVEEN, Leusden (NL)

(21) Appl. No.: 18/565,994

(22) PCT Filed: Jun. 7, 2022
(86) PCT No.: PCT/EP2022/065387

§ 371 Date: Nov. 30, 2023

Related U.S. Application Data
(60) Provisional application No. 63/209,199, filed on Jun. 10, 2021.

(51) Int. Cl. A23L 27/00; A23L 27/26; A23L 29/212; A23L 29/244; A23L 29/269; A23L 29/30; A23P 10/30

(52) U.S. Cl. CPC A23L 27/70; A23L 27/26; A23L 29/212; A23L 29/244; A23L 29/27; A23L 29/30; A23P 10/30

(57) ABSTRACT

A flavour delivery system is provided. Methods for making the flavour delivery product and the consumables containing the food delivery product are also disclosed. The consumable may be a plant-based meat analogue that closely mimics the flavour, aroma and mouthfeel of animal-based protein products over the entire chewing experience.

### TECHNICAL FIELD

The present disclosure relates to flavour delivery systems. More particularly, the present disclosure relates to delivery systems for controlled release of flavourants in various consumable products, including plant-based products such as meat analogue products.

### BACKGROUND

Many consumable products contain flavourants to provide the product with the desired taste and aroma, and to enhance the products' overall flavour perception in the mouth. However, the complex systems associated with flavourants are often difficult and expensive to control. To limit flavour degradation during processing and storage and to retain aroma and flavour in consumable products, it is beneficial to encapsulate the flavourants prior to use in foods or beverages. However, current delivery systems having encapsulated flavours do not provide an authentic time-intensity flavour profile, particularly when used in plant-based products such as meat analogue products. Rather, these systems deliver a high initial taste peak and lack flavour impact after chewing a couple of times. In addition, when the high initial taste peak drops, off-tastes in the consumable product become quite strong and unpleasant, for example, plant protein off-tastes in meat analogue products. Current flavour delivery systems also have stability issues during shelf life and when added pre-extrusion.

Accordingly, there remains a need for a delivery system that provides a balanced and authentic time-intensity flavour profile in consumable products. There also remains a need to provide a delivery system which reduces or masks off-tastes over an extended period of time in consumable products, such as plant protein off-tastes in meat analogue products. There further remains a need to provide flavourants in a stable form for use in consumable products, so that the flavourant, even when added pre-extrusion, is stable to oxidation and hydrolysis during the shelf life of the consumable products. Novel flavour delivery systems and methods for making said delivery systems are therefore provided by the present invention.

### SUMMARY

Disclosed is a flavour delivery system comprising spray-dried particles comprising a water-soluble matrix and at least one flavourant encapsulated in the matrix; and flavour granules comprising a core material and a flavourant on the core material.

Additionally disclosed is a consumable product comprising one or more flavour delivery systems dispersed therein. Further disclosed is a consumable product comprising an edible non-animal protein base, and one or more of the flavour delivery systems dispersed within the edible non-animal protein base.

Further disclosed is a method for making a flavour delivery system comprising (a) preparing spray-dried particles by forming a water-soluble matrix, dissolving the matrix in water, adding at least one flavourant to the mixture, mixing the matrix and at least one flavourant to form an emulsion, and drying the emulsion; (b) preparing flavour granules by blending a native starch, xanthan gum and/or konjac in a fluidised bed to form a core material and spraying a flavour emulsion on to the core material to give fluidised flavour granules; and (c) mixing the (a) spray-dried particles and the (b) flavour granules to form the delivery system.

Further disclosed is a method for making a consumable product comprising mixing an edible plant-based protein base with one or more of the flavour delivery systems together to form a mixture, and forming the mixture into a solid.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The present disclosure relates to flavour delivery systems for delivering balanced and authentic time-intensity flavour profiles to consumers in various food and beverage products, particularly meat analogues products. The result is not only highly stable flavours, that avoid flavour degradation even when added pre-extrusion, but also highly authentic flavour release over an extended period of time.

“Authentic time-intensity flavour profile” refers to flavour delivery systems effective in providing a long lasting and overall more balanced and authentic flavour. Current flavour delivery systems do not provide an authentic time-intensity flavour profile. Rather, these systems deliver a high initial peak and lack flavour impact after chewing a couple of times. For example, plant-based protein products containing conventional flavour delivery systems lack an authentic meaty flavour in burgers/meat analogues (beef, fatty-tallow, porky, chicken, etc.) after chewing a couple of times. In particular, such delivery systems in burgers/meat analogue products provide an initial burst of meaty flavour but then quickly, after chewing a couple times, the meaty flavour is diminished and overtaken by plant protein off-tastes. On the other hand, the disclosed flavour delivery system provides a balanced and authentic flavour release over the entire chewing experience. It has surprisingly been found that plant-based protein products containing the disclosed flavour delivery system closely mimic the flavour, aroma and mouthfeel of animal-based protein products over the entire chewing experience. For example, a soy burger patty containing the disclosed flavour delivery system exhibits flavour, aroma and mouthfeel characteristics that are the same or similar to the flavour, aroma and mouthfeel characteristics of an animal-based burger patty over the entire chewing experience.

One of the most important criterion for consumer acceptance of foods is flavour. In response, Applicant has developed a delivery system that makes it possible to deliver flavourants to consumers in various consumable products such that consumer preferred levels of a flavourant are maintained over an extended period of time. The delivery systems according to the present disclosure, effectively entrap the flavourants and/or prevent degradation thereof during storage and processing, for example when incorporated in a food or beverage, and will release the flavourant with a controllable delay under specific conditions. The disclosed flavour delivery system can significantly enhance the authentic time-intensity flavour profile in consumable products such as a meat analogue product.

According to the present disclosure, the flavour delivery system may comprise i) spray-dried particles comprising a water-soluble matrix and at least one flavourant encapsulated in the matrix; and ii) flavour granules comprising a core material and a flavourant on the core material. The spray-dried particles, flavour granules and/or the flavour delivery system may also include other optional ingredients for particular applications.

One or more of the flavour delivery systems can be dispersed throughout a food base to create a food product containing the flavour delivery system. According to further illustrative embodiments, one or more of the flavour delivery systems are dispersed throughout a plant-based or vegetarian protein base to create a meat analogue product containing the flavour delivery system. The appearance, flavour, and texture of the meat analogue product is similar to that of certain real meat products.

The delivery system of the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed. It may be placed in the mouth before being consumed, or it may be held in the mouth for a period of time before being discarded. Broadly, consumables include, but are not limited to, foodstuffs of all kinds, confectionery products, baked products, sweet products, savoury products (including the meat analogue products, real meat products, and hybrid real meat meat products), vegetable flavoured and vegetable products, fermented products, dairy products, beverages, oral care products, nutraceuticals and pharmaceuticals.

According to certain embodiments, the consumable product is a product that can be considered to be a “clean-label” product. The “clean-label” movement is a consumer movement or trend driven by health and nutrition conscious consumers. The term “clean-label” is a term that has been adopted by the food industry, consumers, academics, and governmental regulatory agencies. A “clean-label” product is a consumable product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

Also disclosed is a solid consumable product comprising a consumable product base and the disclosed flavour delivery system. By “solid” is meant a product that is not fluid, i.e., not a liquid or a spreadable paste. By “consumable product base” is meant all of the art-recognised ingredients that are combined with the flavour delivery system to make a consumable product. These will depend on the nature of the particular product, but they include materials such as other flavours, binders and film-forming materials, thickeners, rheology modifiers, extenders and abrasive agents, emulsifiers, solvents and diluents, pigments, dyestuffs and colouring matters, preservatives, flavour enhancers and modifiers, sweeteners, mouthfeel additives, antiseptics and medicinal compounds and compositions, and the like. According to certain embodiments, disclosed is a gelatin-free solid consumable product base and the disclosed flavour delivery system. According to certain embodiments, the flavour delivery system is gelatin-free. According to certain embodiments, the spray-dried particles and/or flavour granules in the delivery system are gelatin-free.

The flavour delivery system may be used to prepare a wide variety of animal based (for example, processed meat) or non-animal based (for example, plant-based) consumable or otherwise edible food products, consumable or otherwise edible animal-based food products, and consumable or otherwise edible food products comprising a combination of animal-based components and non-animal based components. According to certain embodiments, the consumable product is a vegetarian food product. In other embodiments, the consumable product is a vegan food product containing only plant-derived components and no animal-derived components. According to certain embodiments, the flavour delivery system may be used to prepare a wide variety of consumable or otherwise edible non-animal based meat analogue, meat replica, cultivated meat, cultured meat, clean meat, in vitro meat, synthetic meat, cell-based meat, hybrid meat comprising a plant-originated substance with cultured animal cells or meat substitute products. According to certain embodiments, a plant-based burger patty comprising the flavour delivery system may be prepared by an additive manufacturing or 3D printing process. Suitable non-animal based consumable products can be formulated, for example, without limitation, as hot dogs, burgers, ground meat, sausage links, sausage patties, kebabs, canned products, steaks, filets, roasts, breasts, thighs, wings, meatballs, meatloaf, bacon, strips, fingers, nuggets, cutlets, and cubes. “Meat analogue” is a food product that approximates the aesthetic qualities and/or chemical characteristics of certain types of meat. The term meat analogue includes those prepared with textured vegetable proteins (TVP), high moisture meat analogue (HMMA) and low moisture meat analogue (LMMA) products.

Exemplary plant proteins include soy protein and pea protein. As used herein, soy includes all consumables containing soy in any form, including soybean oil used either alone, in combination, for example as a nutraceutical, or as a medicament, soybean curd, soy milk, soy butter or soy paste. The plant protein may comprise algae (such as spirulina), beans (such as black beans, canelli beans, kidney beans, lentil beans, lima beans, pinto beans, soy beans, white beans), broccoli, edamame, mycoprotein, nuts (such as almonds, brazil nuts, cashews, peanuts, pecans, hazelnuts, pine nuts, walnuts), peas (such as black eyed peas, chickpeas, green peas), potatoes, oatmeal, seeds (such as chia, flax, hemp, pumpkin, sesame, sunflower), seitan (i.e., wheat gluten-based), tempeh, tofu, and mixtures thereof. According to certain embodiments, the plant protein is a potato-derived protein. Without limitation, a suitable potato protein is commercially available from Avebe under the trademark SOLANIC® (Veendam, The Netherlands). In another embodiment, the non-animal protein is selected from the group consisting of grain, legume, pulses, seed, oilseed, nut, algal, mycoprotein, fungal protein, insects, leaf protein and combinations thereof.

According to certain embodiments, the consumable or edible food product comprises a non-animal-based burger patty comprising a non-animal food base and one or more of the flavour delivery systems. Without limitation, the plant-based protein base may comprise a textured vegetable protein that is combined with one or more of the flavour delivery systems. Disclosed is a method for making a vegetarian or vegan food product, the method comprising mixing together an edible plant-based protein base and one or more of the flavour delivery systems together to form a mixture and forming the mixture into a solid or semi-solid form.

Food scientists have devoted much time developing methods for preparing acceptable meat-like food applications, such as beef, pork, poultry, fish, and shellfish analogs, from a wide variety of non-animal proteins. One such approach is texturization into fibrous meat analogs, for example, through extrusion processing. The resulting meat analog products exhibit improved meat-like visual appearance and improved texture. The flavour delivery system may be prepared by high-moisture (wet) and/or low-moisture (dry) extrusion processes.

A suitable extrusion process for the preparation of a meat analog product comprises introducing non-animal protein component, the carbohydrate component, the flavour delivery system into a mixing tank (i.e., an ingredient blender such as a ribbon blender or equivalent mixer) to combine the ingredients and form a dry blended pre-mix. The dry blended pre-mix is then transferred to a hopper from which the dry blended ingredients are fed to an extruder in which the dry ingredients and injected water are mixed and heated under mechanical pressure generated by the screws of the extruder to form a molten extrusion mass. The molten extrusion mass exits the extruder through an extrusion die. It has surprisingly been found that the flavourants in the disclosed delivery system remain in a stable form even after being subjected to extrusion processing.

In another embodiment according to the present disclosure, the flavour delivery system and any additional ingredients may be added to the meat analog products post-extrusion. In one example, a meat analog product such as soy burger patties may be formed as described above except that the flavour delivery system is not added prior to extrusion. Rather, the extrusion mass of non-animal protein may be chopped into pieces and blended with the flavour delivery system. In certain embodiments, the blended mixture may then be shaped into burger patties, cooked, cooled down, frozen and packaged.

Also disclosed is a method for reducing or eliminating flavour loss perception in meat analog products. The method comprises mixing the disclosed flavour delivery system with a non-animal protein base to form a meat analogue product.

In certain embodiments, the delivery system may comprise spray-dried particles and flavour granules in a ratio of about 1:50 to 50:1, respectively. In certain embodiments, the delivery system may comprise spray-dried particles and flavour granules in a ratio of about 1:20 to 20:1, respectively. In certain embodiments, the delivery system may comprise spray-dried particles and flavour granules in a ratio of about 1:10 to 10:1, respectively. In certain embodiments, the delivery system may comprise spray-dried particles and flavour granules in a ratio of about 1:5 to 5:1, respectively. In certain embodiments, the delivery system may comprise spray-dried particles and flavour granules in a ratio of about 1:4 to 4:1, respectively. In certain embodiments, the delivery system may comprise spray-dried particles and flavour granules in a ratio of about 1:3 to 3:1, respectively. In certain embodiments, the delivery system may comprise spray-dried particles and flavour granules in a ratio of about 1:2 to 2:1, respectively. In certain embodiments, the delivery system may comprise spray-dried particles and flavour granules in a ratio of about 1:1.

In certain embodiments, the consumable product may comprise the flavour delivery system in an amount of from about 0.0001% weight percent to about 10 weight percent, based on the total weight of the consumable product. In certain embodiments, the consumable product may comprise the flavour delivery system in an amount of from about 0.001% weight percent to about 5 weight percent, based on the total weight of the consumable product. In certain embodiments, the consumable product may comprise the flavour delivery system in an amount of from about 0.01% weight percent to about 5 weight percent, based on the total weight of the consumable product. In certain embodiments, the consumable product may comprise the flavour delivery system in an amount of from about 0.1% weight percent to about 3 weight percent, based on the total weight of the consumable product. In certain embodiments, the consumable product may comprise the flavour delivery system in an amount of from about 0.1% weight percent to about 1 weight percent, based on the total weight of the consumable product. In certain embodiments, the consumable product may comprise the flavour delivery system in an amount of from about 0.1% weight percent to about 0.5% weight percent, based on the total weight of the consumable product. In certain embodiments, the consumable product may comprise the flavour delivery system in an amount of from about 0.1% weight percent to about 0.3% weight percent, based on the total weight of the consumable product.

The delivery system may be added to a consumable product in any number of ways, as would be appreciated by those of ordinary skill in the art given the benefit of this disclosure. In certain exemplary embodiments, the delivery system is sufficiently mixed in the consumable to provide a substantially uniform distribution, for example a stable dispersion. Mixing should be accomplished such that the spray-dried particles and flavour granules are not destroyed. If the spray-dried particles and/or flavour granules are destroyed, premature release (exposure) of flavour and oxidation or hydrolysis of the flavourant may result. The mixer(s) can be selected for a specific application based, at least in part, on the type and amount of ingredients used, the viscosity of the ingredients used, the amount of product to be produced, the flow rate, and the sensitivity of ingredients to shear forces.

The spray-dried particles and flavour granules of the delivery system comprise at least one flavourant. By “flavourant” it is meant a composition created by a flavourist using methods known to the skilled person that is a mixture of tastants, aroma compounds and/or sensates. The flavourant may be a liquid, gel, colloid, or particulate solid, for example, an oil, an extract, an oleoresin, or the like. In certain embodiments, flavourants may include any one or more food-grade flavourants that do not substantially dissolve in water. In certain embodiments, the delivery systems comprise at least one non-aqueous flavourant. Examples of flavourants, in particular aromatic or volatile flavourants, to be encapsulated in the matrices according to the present disclosure are for instance essential oils, like pepper oil and other volatile flavourants, like savoury flavourants.

The at least one flavourant in the spray-dried particles and flavour granules of the delivery system may the same or different, and may be any suitable desired flavour. The spray-dried particles and/or flavour granules may include a sufficient amount of the at least one flavourant to impart a desired level of flavour or taste. A single flavourant or combinations of two or more flavourants may be included in the spray-dried particles and/or flavour granules to prepare a variety of consumable products having different flavours or tastes. Without limitation, and only by way of illustration, the flavourants may include beef flavour, pork flavour, veal flavour, chicken flavour, duck flavour, goose flavour, lamb flavour, turkey flavour, fish flavour, seafood flavours (including, for example, lobster, clam, crab, mussel, scallop, shrimp, oyster) fruity flavours, seasonings, spices, herbs, sweet tastants, salty tastants, umami tastants, taste enhancers, taste modifiers, and the like. According to certain embodiments, the spray-dried particles and flavour granules comprise a beef and/or wagyu flavourant. There may also be one or more acids present in the taste component to induce succulence and saliva production.

Examples of suitable flavourants include natural flavours, artificial flavours, spices, seasonings, and the like. Exemplary flavourants include synthetic flavour oils and flavouring aromatics and/or oils, oleoresins, essences, and distillates, and a combination comprising at least one of the foregoing. Generally any flavourant or food additive such as those described in “Chemicals Used in Food Processing”, Publication No 1274, pages 63-258, by the National Academy of Sciences, can be used.

The amount of flavourant included in the spray-dried particles and flavour granules of the delivery system may vary depending on the application and desired taste characteristics of the consumable product. In certain embodiments, the spray-dried particles may include about 1 to about 50 wt. % of the at least one flavourant. In certain embodiments, the spray-dried particles may include about 2 to about 40 wt. % of the at least one flavourant. In certain embodiments, the spray-dried particles may include about 3 to about 30 wt. % of the at least one flavourant. According to certain embodiments, the spray-dried particles may include about 5 to about 25 wt. % of the at least one flavourant. In certain embodiments, the spray-dried particles may include about 10 to about 20 wt. % of the at least one flavourant.

In certain embodiments, the flavour granules may include about 1 to about 50 wt. % of the at least one flavourant. In certain embodiments, the flavour granules may include about 1 to about 40 wt. % of the at least one flavourant. In certain embodiments, the flavour granules may include about 5 to about 30 wt. % of the at least one flavourant. In certain embodiments, the flavour granules may include about 5 to about 25 wt. % of the at least one flavourant. In certain embodiments, the flavour granules may include about 10 to about 15 wt. % of the at least one flavourant.

According to certain embodiments, the at least one flavourant is combined with a suitable emulsifier in an amount effective to form an emulsion. Any emulsifier that is generally regarded as safe for inclusion in an edible food product that is intended for human or pet consumption, and that is capable of emulsifying a flavourant to create the emulsion, may be used as an emulsifier for preparing the disclosed flavour delivery system. In some cases, the flavourant may be emulsified without the need for any emulsifiers.

The emulsifiers may be anionic emulsifiers, cationic emulsifiers, non-ionic emulsifiers and amphoteric emulsifiers. Without limitation, and only by way of illustration, suitable emulsifiers include celluloses, monoglycerides, diglycerides, acylated monoglycerides, lactylated monoglycerides succinylated monoglycerides, alkoxylated monoglycerides (such as ethoxylated monoglycerides), alkoxylated diglycerides (such as ethoxylated diglycerides), esters of monoglycerides (such as diacetyl tartaric acid esters of monoglycerides), lethicins (such as soy lecithin and lecithin from egg yolk), modified food starches, gum arabic, octenyl succinic anhydride (OSA) starch, starch sodium octenyl succinate, Quillaya saponins, magnesium stearate, calcium, potassium and sodium salts of fatty acids, polysorbates, alkali metal stearoyl lactylate (such as sodium stearoyl lactylate), sugar esters, alkaline earth metal stearoyl lactylate (such as calcium stearoyl lactylate), sodium phosphates and mixtures thereof. In certain embodiments, the emulsifier is derived from sorbitan. Without limitation, a suitable emulsifier derived from sorbitan is polyoxyethylene sorbitan monooleate, commercially available, for example, under the trade names TWEEN, POLYSORBATE and ADMUL.

The spray-dried particles in the delivery system comprise a water-soluble matrix and at least one flavourant encapsulated in the matrix. The flavour-encapsulating matrix of the spray-dried particles may comprise at least one water soluble molecule. The at least one water soluble compound may be a carbohydrate selected from the group consisting of a monosaccharide, a disaccharide, an oligosaccharide, a corresponding polyhydroxy compound, and combinations thereof. The carbohydrate may be selected from the group consisting of glucose, fructose, maltose, sucrose, lactose, maltodextrin, inulin and combinations thereof. The polyhydroxy compound may be selected from the group consisting of xylitol, mannitol, sorbitol, lactitol, maltitol, isomalt and combinations thereof.

The flavour-encapsulating matrix of the spray-dried particles may comprise an emulsifier. Without limitation, a suitable emulsifier is starch sodium octenyl succinate. The flavour-encapsulating matrix of the spray-dried particles may comprise a filler. Without limitation, a suitable filler is potato maltodextrin. The spray-dried particles may also include at least one film forming agent. In certain embodiments, the film forming agent is selected from the group consisting of protein, gum arabic, pectin, modified starch, a polyglycerol fatty acid ester, and combinations thereof. In certain embodiments, the spray-dried particles comprise a water-soluble matrix including from about 5% to about 30% emulsifier; from about 20% to about 75% filler; and from about 20% to about 50% mono, di and trisaccharides, based on the total weight of the matrix.

In certain embodiments, the spray-dried particles and/or flavor granules in the delivery system have a particle size from about 10 to about 400 microns. In certain embodiments, the spray-dried particles and/or flavor granules in the delivery system have a particle size from about 20 to about 200 microns. In certain embodiments, the spray-dried particles and/or flavor granules in the delivery system have a particle size from about 50 to about 100 microns.

The spray-dried particles according to the present disclosure may be produced using standard spray drying equipment and typical conditions known to the art. In certain embodiments, spray-dried particles according to the present disclosure may be produced using multistage dryer (MSD) equipment and typical conditions known in the art. Conditions may naturally vary depending on the nature of the equipment and the material being sprayed, but the person skilled in the art can readily determine the appropriate conditions in every case with only routine experimentation. Typical examples of conditions that produce dry powder with a moisture content of less than 5% and water activity in the desirable range of from 0.05 to 0.30 at 25° C. Water activity (A_{w}) is the partial vapor pressure of water in a substance divided by the standard state partial vapor pressure of water. It is a measurement of the relative humidity of the sample in a closed chamber—basically A_{w} is the equilibrium humidity emitted by the sample material.

Typical parameters for use on a conventional tower spray dryer are:
Inlet temperature—100-250° C.
Outlet temperature—60-120° C.

The finished material size can be about greater than or equal to about 40 μm mean diameter by volume distribution, as measured by laser diffraction particle size instrument. Other non-limiting examples of suitable drying techniques include fluid bed drying, freeze drying, filtermat and drum drying.

According to certain embodiments, the spray-dried particles are prepared by forming an aqueous solution containing the matrix materials; incorporating the at least one flavourant, such as Wagyu flavour, into the solution and forming an emulsion or suspension, whereby the emulsion or suspension contains, on a non-aqueous basis, between 1-40% by weight of the flavourant; and spray drying the emulsion or suspension in a spray drying tower at an air inlet temperature of 100-180° C. and an air outlet temperature of 60-95° C., and optionally further drying and agglomerating at an air temperature between 25-60° C. to produce a free-flowing, dust-free powder of spray-dried particles.

According to certain embodiments, the spray-dried particles are prepared by the steps of (1) preparing an aqueous solution of the matrix materials, (2) mixing the at least one flavourant into the aqueous solution with stirring to form an emulsion or suspension, (3) spraying the emulsion in a spray drying tower under a supply of hot air to quickly create a solid or semi-solid skin, and optionally (4) subsequently subjecting the resulting particles to continued drying at lower temperatures in a fluid bed. The described process allows for the production of flavourants encapsulated in a glassy matrix in the form of free-flowing, dust-free powder of spray-dried particles. These spray-dried particles can be produced in a continuous process cycle and with higher flavour loads, thus resulting in significantly lower production costs and costs in use.

If the at least one flavourant is a water-insoluble liquid, especially a flavour oil, in order to build an emulsion or suspension, the flavourant can be added to the aqueous solution of matrix materials. The mixture is then homogenized until its droplet/particle size is between about 0.2 and 10 μm, preferably about 1-2 μm, whereby the emulsion or suspension is preferably adjusted to a viscosity of about 400-1000 cP at 40° C. According to certain embodiments, the amount of the flavourant in the emulsion or suspension is, on a non-aqueous basis, from about 1-30% by weight, optionally from 5 to 25%, further optionally from 10-20%.

In certain embodiments, the spray-dried particles are dried in two steps. In the first step the emulsion, which is heated to between about 30 to about 50° C., is sprayed into the spray drying tower in the form of fine drops built by means of a rotating disc or a nozzle, where they meet a stream of air at a temperature of between 130-180° C., more particularly at a temperature of between 145-165° C. As a result, the matrix material in the outer part of the drops solidifies, forming particles with a skin that is still permeable for water but no longer permeable for flavourants. The temperature of the hot air is kept high enough so that migration of moisture from the inside to the outside may take place within a short time, but kept low enough to prevent an explosion of steam in the droplets. Otherwise, explosion of steam would increase porosity, and hence make the matrix also permeable to flavours and oxygen, yielding flavour loss, either as liquid or by volatilization and/or oxidation of the flavours. Therefore, the temperature at the outlet of the spray dryer is normally kept at 95° C. or below 95° C., specifically in the range of 60-95° C.

In the second step of the process, the powder is fluidized in the internal fluid bed where some agglomeration takes place, which is supported by the residual moisture in the particles, which softens the surface when migrating from the inside to the outside of the particles. Residence time in the internal fluid bed is normally about 10 to 30 minutes and depends on the size of the envisaged particle size distribution of the end product agglomeration which may be from about 100 to about 1500 microns, preferably from about 250 to about 1250 microns, most preferably from about 400 to about 1000 microns. Incoming air at a temperature from 25-60° C., specifically at a temperature of about 40-50° C., passing through the fluid bed, further dries the particles. Those particles having the envisaged size are separated or collected, e.g. sieved off, and the fines are recirculated. Thus, particles are continuously dried and removed. The separated particles have a bulk density of at least 0.4 g/ml and a moisture content of 0.5-4% by weight.

The flavour granules in the delivery system comprise a core material and a flavourant on the core material. According to certain embodiments, the core material comprises starch, xanthan gum and/or konjac. According to certain embodiments, the core material comprises starch, xanthan gum and konjac. According to certain embodiments, the starch is finely-divided native starch, i.e., non-chemically-modified starches. Without limitation, and only by way of illustration, suitable native starches include rice, potato and tapioca starch. Xanthan gum is a polysaccharide secreted by the bacterium Xanthomonas campestris. Konjac is the root of an Asian plant Amorphophallus konjac. Without limitation, konjac may be used in powder (flour) or gel form.

The at least one flavourant in the flavour granules may be in the form of an aqueous emulsion. In some cases, the flavourant may be emulsified without the need for any emulsifiers, but in general the presence of at least some food-grade emulsifier is beneficial. In certain embodiments, the emulsifier comprises gum Arabic, modified food starches and/or OSA starch. According to certain embodiments, the emulsifier is derived from sorbitan. In certain embodiments, polyoxyethylene sorbitan monooleate is utilized, commercially available, for example, under the trade names TWEEN, POLYSORBATE and ADMUL. It has been surprisingly found that the use of these emulsifiers results in emulsifier flavour droplets of unusually small size (down to 1 micron), as opposed to the 3-4 micron size possible with other emulsifiers. The larger the droplets, the greater the flavour loss in the fluidised bed process, so a smaller size brings considerable advantages.

In certain embodiments, the flavour granules comprise a core material including from about 40% to about 70% native starch; from about 10% to about 30% xanthan gum; and from about 10% to about 30% konjac, based on the total weight of the core material.

According to certain embodiments, the core material is prepared by mixing the ingredients in a heated fluidised bed. An emulsion of the flavour is then sprayed on to the core material. Spraying is continued until a desired flavour content is attained. Without limitation, suitable fluidised bed equipment include Wurster, rotor granulator and top spray systems.

The fluidised bed equipment is operated according to the normal practices and within the recognised parameters of the art. Typical operating conditions are as follows:
Inlet temperature 60-110° C., particularly about 95° C.
Product Temperature 35-90° C., particularly about 65° C.
Air flow rate 20-140 M³/h, particularly about 60 M³/h
Nozzle air pressure 0.5-6 bar, particularly about 4 bar

According to certain embodiments, at least one coating layer may be applied to the flavour granule. A coating layer may be any food-grade material capable of forming a coating film. Without limitation, a suitable coating layer may be composed of cellulosic materials such as methyl and ethyl cellulose, and starch-based materials. The coating layer may be sprayed as an aqueous solution on to the fluidised flavour granules.

Also disclosed is a method for making a flavour delivery system comprising (a) preparing spray-dried particles by forming a water-soluble matrix, dissolving the matrix in water, adding at least one flavourant to the mixture, mixing the matrix and at least one flavourant to form an emulsion, and drying the emulsion; (b) preparing flavour granules by blending a native starch, xanthan gum and/or konjac in a fluidised bed to form a core material and spraying a flavour emulsion on to the core material to give fluidised flavour granules; and (c) mixing the (a) spray-dried particles and the (b) flavour granules to form the delivery system.

Also disclosed is an edible food product. The edible food product may comprise a vegetarian or vegan food product. The food product may comprise a vegetarian or vegan meat analogue product. In certain embodiments, the food product is a solid or semi-solid food that may comprise an edible plant-based protein base and a plurality of flavour delivery systems that are dispersed within the edible plant-based protein base. The amounts of the non-animal protein base and the flavour delivery systems of the food product can be adjusted to provide the final meat analogue food product having the appearance, flavour and texture of certain types of real meat.

Further disclosed is a method for making a food product that does not include any animal derived components, or that is substantially free of any animal derived components. The method comprises mixing an edible non-animal protein base with the disclosed flavour delivery systems to form a mixture and forming the mixture into a solid or semi-solid form.

### EXAMPLES

The following examples are given solely for the purpose of illustration and are not to be construed as limitations of the present invention, as many variations of the invention are possible without departing from the spirit and scope of the present disclosure.

### Example 1

A sample of an illustrative embodiment of the presently disclosed flavour delivery system was prepared. Spray-dried particles were prepared by adding 673 grams of maltodextrin solution and 84 grams of starch sodium octenyl succinate to 137.8 grams of water. 105 grams of a beef top note flavourant was added to the solution and stirred to form an emulsion. The emulsion was spray dried in a spray drying tower at an air inlet temperature of 100-180° C. and an air outlet temperature of 60-95° C. The core material of the flavour granules was prepared by mixing 126 grams of potato starch, 42 grams of xanthan gum and 42 grams of konjac in a heated fluidised bed to a temperature of about 65° C. An emulsion containing 700 grams of water, 441 grams of gum arabic and 215 grams of beef top note flavourant was sprayed on to the core material. The spray-dried particles and flavour granules were then combined at certain ratios to form the flavour delivery system.

### Example 2

A sample of another illustrative embodiment of the presently disclosed flavour delivery system was prepared. Spray-dried particles were prepared by adding 673 grams of maltodextrin solution and 84 grams of starch sodium octenyl succinate to 137.8 grams of water. 105 grams of a beef top note flavourant was added to the solution and stirred to form an emulsion. The emulsion was spray dried in a spray drying tower at an air inlet temperature of 100-180° C. and an air outlet temperature of 60-95° C. The core material of the flavour granules was prepared by mixing 126 grams of potato starch, 42 grams of xanthan gum and 42 grams of konjac in a heated fluidised bed to a temperature of about 65° C. An emulsion containing 796 grams of water, 4.1 grams of polyoxyethylene sorbitan monooleate, 146 grams of maltodextrin, 146 grams of Isomalt (sugar alcohol), 294 grams of gum arabic and 197 grams of beef top note flavourant was sprayed on to the core material. The spray-dried particles and flavour granules were then combined at different ratios to form the flavour delivery system.

### Analysis of Plant-Based Meat Analogue Via Pre-Extrusion

### i) Spray-Dried Particles Only

A plant-based meat analogue product comprising a soy protein base and about 0.15 weight percent of the spray-dried particles, based on the total weight of the meat analogue product, was subjected to an extrusion process and evaluated by a panel of trained food tasters. The results indicate that the plant-based meat analogue product exhibited high initial taste peak and lacked flavour impact after chewing a couple of times. In addition, when the high initial taste peak dropped, plant protein off-tastes present in the soy protein base became quite strong and unpleasant.

### ii) Flavour Granules Only

A plant-based meat analogue product comprising a soy protein base and about 0.15 weight percent of the flavour granules, based on the total weight of the meat analogue product, was subjected to an extrusion process and evaluated by a panel of trained food tasters. The results indicate that the plant-based meat analogue product exhibited low initial taste peak and flavour impact increased after chewing a couple of times. In addition, initially unpleasant plant protein off-tastes were present, which were masked by the flavor granules after chewing a couple times.

iii) Combination of Spray-Dried Particles and Flavour Granules

A plant-based meat analogue product comprising a soy protein base and about 0.15 weight percent of the presently disclosed plant-based flavour delivery system (about 0.1 weight percent of the flavour granules and about 0.05 weight percent of the spray-dried particles) was subjected to an extrusion process and evaluated by a panel of trained food tasters. The results indicate that the plant-based meat analogue product exhibited a long lasting and overall balanced and authentic beef flavour with no plant protein off-tastes.

### Analysis of Plant-Based Meat Analogue Via Post-Extrusion

### i) Spray-Dried Particles Only

A plant-based burger comprising a soy protein base was subjected to an extrusion process. About 0.15 weight percent of the spray-dried particles, based on the total weight of the meat analogue product, were added to the extruded plant-based burger and evaluated by a panel of trained food tasters. The results indicate that the plant-based meat analogue product exhibited high initial taste peak and lacked flavour impact after chewing a couple of times. In addition, when the high initial taste peak dropped, plant protein off-tastes present in the soy protein base became quite strong and unpleasant.

### ii) Flavour Granules Only

A plant-based burger comprising a soy protein base was subjected to an extrusion process. About 0.15 weight percent of the flavour granules, based on the total weight of the meat analogue product, were added to the extruded plant-based burger and evaluated by a panel of trained food tasters. The results indicate that the plant-based meat analogue product exhibited low initial taste peak and flavour impact increased after chewing a couple of times. In addition, initially unpleasant plant protein off-tastes were present, which were masked by the flavor granules after chewing a couple times.

iii) Combination of Spray-Dried Particles and Flavour Granules

A plant-based burger comprising a soy protein base was subjected to an extrusion process. About 0.15 weight percent of the presently disclosed plant-based fat delivery system (about 0.1 weight percent of the flavour granules and about 0.05 weight percent of the spray-dried particles) were added to the extruded plant-based burger and evaluated by a panel of trained food tasters. The results indicate that the plant-based meat analogue product exhibited a long lasting and overall balanced and authentic beef flavour with no plant protein off-tastes.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

While the flavour delivery systems, the food products including the flavour delivery systems, and methods of making the flavour delivery systems and food products have been described in connection with various embodiments, it is to be understood that other similar embodiments may be used or modifications and additions may be made to the described embodiments for performing the same function. Furthermore, the various illustrative embodiments may be combined to produce the desired results. Therefore, the flavour delivery systems, the food products including the flavour delivery systems, and methods of making the flavour delivery systems and food products should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A flavour delivery system comprising stable, spray-dried particles comprising a water-soluble matrix selected from the group consisting of glucose, fructose, maltose, sucrose, lactose, maltodextrin, inulin, xylitol, mannitol, sorbitol, lactitol, maltitol, isomalt, and combinations thereof and at least one flavourant encapsulated in the matrix; and flavour granules comprising a core material and at least one flavourant on the core material.

2. The flavour delivery system of claim 1, wherein the flavour delivery system is gelatin free.

3. The flavour delivery system of claim 1, wherein the matrix of the spray-dried particles comprises at least one water soluble compound selected from the group consisting of a monosaccharide, a disaccharide, an oligosaccharide, a corresponding polyhydroxy compound, and combinations thereof.

4. The flavour delivery system of claim 3, wherein the monosaccharide, disaccharide or oligosaccharide is selected from the group consisting of glucose, fructose, maltose, sucrose, lactose, maltodextrin, inulin, and combinations thereof.

5. (canceled)

6. The flavour delivery system of claim 1, wherein the matrix of the spray-dried particles comprises 5% to 30% emulsifier; 20% to 75% filler; and 20% to 50% mono, di and trisaccharides, based on the total weight of the matrix.

7. The flavour delivery system of claim 1, wherein the spray-dried particles have an average particle size of 20 to 150 microns.

8. The flavour delivery system of claim 1, wherein the at least one flavourant is present in the spray-dried particles in an amount of from 1% to 30%, based on the total weight of the matrix.

9. The flavour delivery system of claim 1, wherein the at least one flavourant in the spray-dried particles and the flavour granules is a non-aqueous flavourant.

10. The flavour delivery system of claim 1, wherein the core material of the flavour granules comprises starch, xanthan gum and/or konjac.

11. The flavour delivery system of claim 10, wherein the core material of the flavour granules comprises 40% to 70% native starch; from 10% to 30% xanthan gum; and/or from 10% to 30% konjac, based on the total weight of the core material.

12. The flavour delivery system of claim 1, wherein the flavour granules are at least partially coated with a coating material comprising cellulosic or starch material.

13. The flavour delivery system of claim 1, wherein the core material of the flavour granules is coated with an emulsion comprising the at least one flavourant and at least one emulsifier.

14. The flavour delivery system of claim 1, wherein the flavour granules have an average particle size of 200 to 1400 microns.

15. The delivery system of claim 1, wherein the spray-dried particles and the flavour granules contain the same flavourant.

16. The delivery system of claim 1, wherein the ratio of the spray-dried particles to the flavour granules is about 0.5-2:3.

17. A consumable product comprising the flavour delivery system of claim 1.

18. The consumable product of claim 17, wherein the consumable product is a clean-label meat analogue product.

19. A plant-based meat analogue comprising an edible non-animal protein base and the flavour delivery system of claim 1 dispersed within said non-animal protein base.

20. A method for preparing a flavour delivery system, comprising:
(a) preparing spray-dried particles by forming a water-soluble matrix selected from the group consisting of glucose, fructose, maltose, sucrose, lactose, maltodextrin, inulin, xylitol, mannitol, sorbitol, lactitol, maltitol, isomalt, and combinations thereof, dissolving the matrix in water, adding at least one flavourant to the mixture, mixing the matrix and at least one flavourant to form an emulsion, and drying the emulsion;
(b) preparing flavour granules by blending a native starch, xanthan gum and/or konjac in a fluidised bed to form a core material and spraying a flavour emulsion on to the core material to give fluidised flavour granules; and
(c) mixing the spray-dried particles and the flavour granules.
